(19) United States
(12) Patent Application Publication
(10) Pub. No.: US 2005/0092325 A1
(43) Pub. Date: May 5, 2005

(54) Aerosol flex tube

(76) Inventor: Cynthia A. Dionne, Hinsdale, IL (US)

Correspondence Address: Basil E. Demeur;Knechtel, Demeur & Samlan, 130 S. Oak Park Avenue, Oak Park, IL, 60302, US

(21) Appl. No.: 10/695,728

(22) Filed: Oct. 30, 2003

(51) Int. Cl. A62B 18/02; A62B 9/04

(52) U.S. Cl. 128/205.25; 128/202.27

(57) ABSTRACT

There is disclosed and improved nebulizer connector tube for inter-connecting between a patient's face mask, and a nebulizer device wherein the nebulizer connector tube is formed from a semi-flexible resilient plastic material and having a bellows type of configuration, the plastic material further including at least a partial memory for maintaining a position once manipulated to such position.

### BACKGROUND OF THE INVENTION

Plastic tubing for inter-connecting one device with another in the medical art field is well known and the art is quite old. A variety of plastic materials are utilized for manufacturing and creating the tubing, suffice it that the plastic material must have certain common characteristics, such as being resilient, non-toxic, non-leaking and having a variety of other such characteristics. A variety of polymers are now routinely utilized for preparing such plastic tubing, the most prevalent being a poly vinyl chloride plastic.

It is well know for example, that plastic tubing is utilized for inter-connecting fluid containers to a patient's body, such as in use of parenteral solutions, blood donation, and the like. Hence, the use of such types of plastic tubing is well known and the art of manufacturing the same has become fairly standard. It is also know that plastic tubing is utilized for inter-connecting devices. For example, the art field with respect to tracheotomy tubes is quite extensive. Endotracheol tubes of various shapes and constructions are well known in the art. For example, U.S. Pat. No. 3,388,705 shows that the endotracheal tube which has a bellows type construction, and is intended for placement as between patient and anesthesia machine. Often times, various adapters and other devices are used for such inter-connection. Tracheal tubes of course are well known for use in patients having a breathing problem, and various types of tubing have been developed for use in applying the same to a patient directly in order to render respiratory care. U.S. Pat. No. 4,000,341 shows a corrugated respiratory care tube structure, which is autoclavable, and therefore re-useable in order to connect to associated medical apparatus.

The art is quite extensive with regard to endotracheal tubes or tracheotomy tubes. However, the art with respect to nebulizer tubing is virtually non-existent. It is well known in the nebulizer art field that where a patient requires a nebulizing treatment, the nebulizer canister, which contains the medicament, is provided with a neck, and a facemask is applied to the neck of the container in order to bring the nebulizer device up to the patient's mouth. The nebulizing treatment is accomplished by the patient breathing in the facemask as the medicament is released from the nebulizing canister. It is therefore necessary that the nebulizer canister or device be maintained in an upright position or the entire nebulizing treatment is ineffective. This poses many problems for the therapist who must render the treatment for the patient for the reason that for very young patients as well as elderly patients, it is difficult to maintain the patient in an upright position. Furthermore, where a patient is unconscious, or semi-conscious, or an elderly patient who is infirm and cannot sit in an upright position, will pose an extremely difficult problem for the therapist who must somehow maintain the patients posture in a position to keep the nebulizer canister in an upright disposition in order to render the treatment required via the nebulizer.

It has there been deemed important to find a way to accommodate various patient postures, during a nebulizing treatment while maintaining the nebulizer canister in an upright disposition. The present invention seeks to obviate the difficulties noted by providing a nebulizer connector tube, which is positioned and interconnects between the facemask and the nebulizer canister.

### OBJECTS AND ADVANTAGES

The principal object of the present invention is to provide a nebulizer connector tube for connecting a patient face mask with the nebulizer device.

In conjunction with the foregoing object, it is a further object to provide a nebulizer connector tube with the type described which is formed of a material which is resilient, flexible, and accommodates the movement of the patient wearing the face mask, while maintaining relative position of the nebulizer in an upright position regardless of the position of the patient.

In conjunction with the foregoing object, it is a further object of the present invention to provide an improved nebulizer connector tube of the type described, wherein the tubing is formed from a material which has at least partial memory such that when the tubing is manipulated to any desired bent position, the tubing will maintain such position to accommodate the patients prone or other position when receiving a nebulizing treatment.

A further object of the present invention is to provide an inter-connection tube of the type described wherein each of the opposed ends of the connector tube is provided with an attachment collar, one end being for attachment to the face mask, and the opposed end being for attachment to the nebulizer device.

In conjunction with the foregoing object, it is a further object of the present invention to provide a nebulizer connector tube of the type described wherein the connector collar for inter-connection of the patient face mask includes a circular channel which will accommodate therein the seatment of the circular flange which is located on the tube fitting portion of the patient face mask. The seatment of the circular flange in the circular channel will accommodate the swivel movement of the tube relative to the face mask and therefore accommodate patient movement during treatment.

A further object is to provide a nebulizer connector tube wherein each end of the tube is formed with appropriate connector collars of different sizes, in order for one end to inter-connect with the nebulizer device which has a certain diametric circular fitting, and for the other end to inter-connect with a patient face mask which has a differently sized diametric fitting.

The above and further object and advantages of the present invention will best be understood by reference to following drawings taken in conjunction with the following specification.

### SUMMARY OF THE INVENTION

In summary, the present invention provides an improved nebulizer connector tube for inter-connecting a patient face mask with a nebulizer device. The improved connector tube is formed of a material which is both flexible, and has a bellows type configuration and is formed of a material which also includes at least a partial memory such that the material, once bent into a particular position, will maintain that position during patient treatment. Furthermore, the nebulizer connector tube of the present invention inter-connects with the patient face mask in a manner to permit the swiveling action of the tube relative to the patient face mask thereby to accommodate some degree of patient movement during the nebulizing treatment without affecting the efficacy of the treatment.

### BRIEF DESCRIPTION OF DRAWINGS

FIG. 1 is a perspective view showing the nebulizer connector tube connected to a typical patient facemask at its inner end, and having an opposed outer end suitable for attachment for a nebulizer device;

FIG. 2 is a plan view showing the nebulizer connector tube of the present invention in an arched disposition and showing the two opposed ends having differently sized diametric circular dimensions;

FIG. 3 is a side view showing the nebulizer connector tube in a 90-degree right angle bent position;

FIG. 4 is a side elevational view showing the nebulizer connector tube connector collar, which inter-connects the facemask tube fitting;

FIG. 5 is an elevational perspective view showing a patient having the patient facemask positioned on the face, and having the nebulizer connector tube inter-connected to the facemask and the nebulizer device incident to a nebulizer treatment.

### DETAILED DESCRIPTION OF DRAWINGS

As shown in FIG. 1, the present invention consists of an elongated nebulizer tube 10, which frictionally engages a face mask 12, which is commonly used in a nebulizer treatment environment. The distal end 14 of the tube 10, connects to a nebulizer device as generally depicted in FIG. 5 of the drawings.

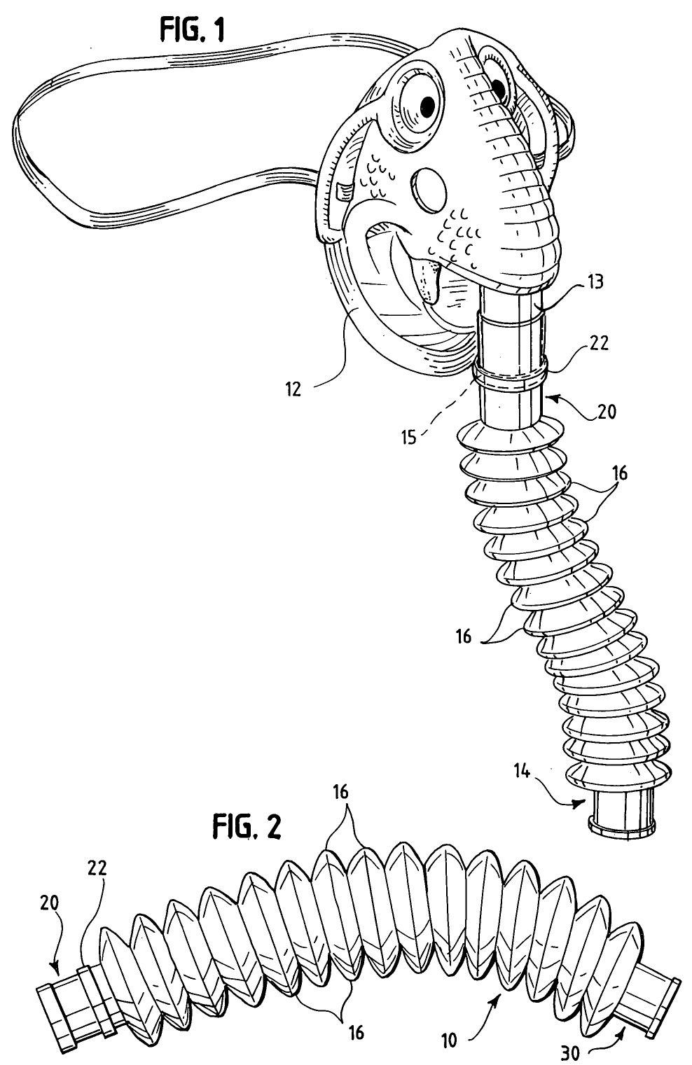

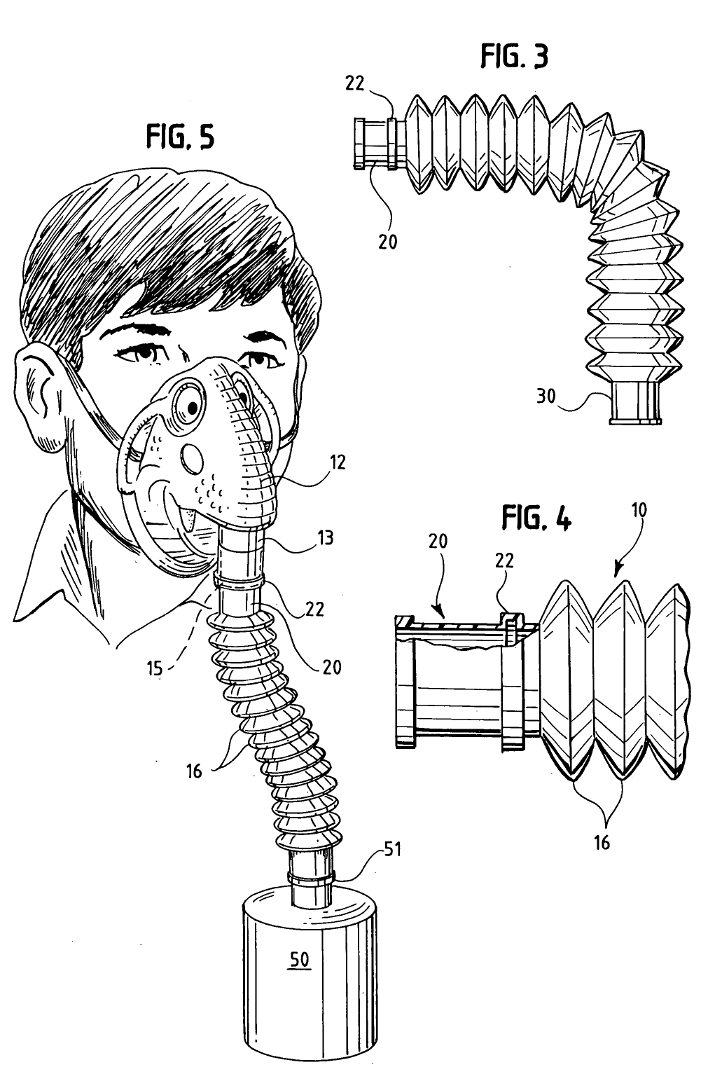

The construction of the elongated nebulizer tube 10 is more precisely shown in FIGS. 2, 3, and 4 of the drawings. The nebulizer tube 10 is of an elongated configuration and is formed from a bellows type of construction generally represented by the numeral 15, along the length thereof. The bellows type construction 16 permits the tube 10 to be configured or bent at any desired angle in order to accommodate the position of the patient relative to the nebulizer device. The tube 10 is ideally formed from an inert, resilient and flexible plastic material, which is generally known in the art. The particular chemical composition of the plastic material is also well know in the art in as much as tubes of this general type have been manufactured for a number of years. Typically, a polyvinylchloride plastic material is utilized.

In the preferred embodiment of the present invention, the plastic material is also selected from those types accommodating at least a partial memory such that once the tube is bent into a desired position, the tube will remain in the bent position as a result of the nature of the material from which it is manufactured, as well as the bellows type construction 16.

Tube 10 is shown to include a face mask connector collar 20 at one end thereof, and a nebulizer connector collar 30 at the opposed end thereof. As is illustrated in FIG. 1 of the drawings, the face mask connector collar 20 is intended to engage and frictionally fit over the face mask tube fitting 13, which is formed as a part of the standard face mask 12. Heretofore, nebulizer face masks are provided with a tube fitting, which interconnects directly with the nebulizer device. The face mask is of a standard construction, and the tube fitting 13 is of a standard circular diametric dimension. Hence, the face mask connector collar 20 is designed to seat over the tube fitting 13 as generally illustrated in FIG. 1. As is further illustrated in FIG. 1, the face mask tube fitting 13 is provided with a circular connection flange 15 while the face mask connector collar is similarly provided with a circular channel 22. The additional advantage provided by the present nebulizer tube 10 of the present invention is that the connector collar 20 will be seated onto and engage the tube fitting 13 with the connection flange 15 being seated within the circular channel 22. In this manner, the tube 10 is permitted some degree of swivel movement relative to the tube fitting 13. The advantage provided by this construction and fitting engagement is that should the patient move during the nebulizing treatment, the elongated nebulizer tube 10 can move relative to the face mask 12 while still maintaining the nebulizer device 50 in its upright stable position as illustrated in FIG. 5. The opposed end of the elongated nebulizer tube 10 includes a nebulizer connector collar 30, which is provided with a circular dimension in order to fit onto a standard nebulizer medicament container. The nebulizer device 50 is generally provided with a neck 51 (FIG. 5), which again is of a standard size. Hence, it will be appreciated that the nebulizer tube 10 of the present invention is provided with a face mask connector collar 20, which is sized diametrically, differently than the nebulizer connector collar 30 at the opposed end of the tube. In this manner, the nebulizer tube 10 of the present invention may be used for a direct connection between the face mask 12, and the nebulizer device 50 thereby to provide an interconnection therebetween which is flexible and moveable.

It will be appreciated from the above description that the construction of the elongated nebulizer tube 10 in accordance with the present invention accommodates the position of the patient receiving the nebulizer treatment in a variety of positions. For example, in many cases, if the patient is in a prone position, and while it is still necessary to maintain the nebulizer device 50 in the upright position in order for the treatment to be effective, the nebulizer tube 10 may be bent by the therapist in a manner to maintain the nebulizer device 50 in the upright position, while the patient is in the prone position. Similarly, if one patient happens to be an elderly patient, and is positioned in a chair but leans to the side, the nebulizer tube 10 may be bent in a manner to maintain a direct path to the nebulizer device 50, while accommodating the off skewed position of the patients head and hence face mask. Furthermore, by constructing the nebulizer tube 10 out of a plastic material which has at least a partial memory, once the therapist bends the tube into the desired position in order to accommodate the patients position relative to the nebulizer device 50, the nebulizer tube 10 will have the tendency to stay in that position and hence, effectuate an effective nebulizer treatment for the patients benefit.

In addition, the nebulizer tube 10 of the present invention eliminates the need for any additional adapters or connectors for interconnecting with the face mask and/or the nebulizer. As has been previously indicated, the face masks which are utilized in conjunction with the nebulizer have a certain standard tube fitting while the nebulizer neck generally has a neck size which fits within the confines of the diametric dimensions of the tube fitting of the face mask. The present nebulizer tube 10 has a proximal end including a connector collar which fits over the tube fitting 13 of the face mask 12, and a distal end including the nebulizer connector collar 14 which is intended to see over the neck 51 of the nebulizer 50. Hence, the tube will directly fit between the face mask 12 and the nebulizer 50 without the need of any special adapters or connectors.

In addition, it will be appreciated that the length of the elongated nebulizer tube 10 may vary depending upon a particular dictates and requirements of the medication and treatment indicated for the patient. It is of course advantageous to maintain the length of the nebulizer tube 10 by a length of somewhere between 4 inches and 8 inches since it is important that a nebulizer device 50 be maintained fairly close to the patients face mask. However, it will be appreciated that the length may be extended in such cases, where, a patient is unconscious and lies in a prone position and the nebulizer 50 must be maintained in an upright position near or adjacent to the patient. It will therefore be appreciated that the present invention affords the manufacturers the ability to format the tube in various lengths to accommodate different situations involving patients requiring treatment.

It will therefore be appreciated from the above description that the present invention has provided a novel and effective method for interconnecting a patient face mask with a nebulizer device in order to render a nebulizing treatment to a patient. The advantages derived from the present invention are that the tube permits a patient to assume a variety of positions including a prone position while still being able to obtain a nebulizing treatment. By providing the nebulizer tube with a bellows type construction, and when made out of a plastic material which has at least a partial memory, the nebulizer tube may be bent in several different manners in order to accommodate the patients position relative to the nebulizer canister. In this manner, the effectiveness of the treatment is not jeopardized by the positioning of the patient, and the therapist rendering the treatment is afforded much less difficult tasks in rendering the treatment.

While there has been described what is at present considered to be the preferred embodiments of the invention, it will be understood that various modifications may be made therein without departing from the spirit and scope of the present invention.

1. A nebulizer connector tube for interconnection between a patient face mask provided with a tube fitting having a standard diametric dimension including a circular connection flange at the outer end thereof, and a nebulizer device provided with a tube fitting of a different circular diametric dimension, comprising,
an elongated tube having a facemask connector collar and a nebulizer connector collar at the opposed end thereof,
said elongated tube formed from an inert, non-toxic plastic material and provided with a bellows type configuration along the length thereof between the face mask connector collar and the nebulizer connector collar,
said bellows type tube being flexible and resilient,
said face mask connector collar being sized to engage a face mask tube fitting and said nebulizer connector collar being sized to engage said nebulizer tube fitting,
whereby said nebulizer connector tube permits the patient receiving a nebulizer treatment to assume any desired position while the connection to the nebulizer allows the nebulizer to retain an upright position.

2. The nebulizer connector tube as set forth in claim 1 above, wherein said face mask connector collar includes a circular channel formed therein and sized to allow the seatment therein of said face mask tube fitting connector flange, whereby said nebulizer tube will swivel relative to said face mask tube fitting to allow patient movement during nebulizer treatment.

3. The nebulizer connector tube set forth in claim 1 above, wherein said nebulizer tube is formed from a material which is further provided with at least a partial memory thereby to retain any position to which said tube is manipulated.

4. The nebulizer connector tube as set forth in claim 1 above, wherein said face mask connector collar is diametrically sized to fit and engage a standard face mask tube fitting and said nebulizer connector collar is sized to fit and engage a standard nebulizer tube fitting.

5. The nebulizer connector tube as set forth in claim 1 above, wherein said nebulizer tube is sufficiently flexible and capable of swivel movement thereby to permit relative movement of said patient relative to the nebulizer device during nebulizer treatment such that said nebulizer maintains and upright position during the nebulizer treatment regardless of the patients position.

6. A nebulizer connector tube for interconnection between a patient face mask provided with a tube fitting having a set diametric dimension and including a connector flange formed along the outer edge thereof, and a nebulizer device provided with a tube fitting of a different diametric set dimension comprising an elongated tube having a face mask connector collar a one end and a nebulizer connector collar at the opposing end thereof,
said elongated tube formed from an inert, non-toxic plastic material and provided with a bellows type of configuration along the length thereof between the face mask connector collar and the nebulizer connector collar,
said nebulizer tube further being formed from a material which is provided with a partial memory thereby to retain any position to which said tube is manipulated,
said face mask connector collar including a circular channel formed therein and sized to allow the seatment therein of said face mask tube fitting connector flange whereby said nebulizer connector tube will swivel relative to said face mask tube fitting to allow for patient movement during nebulizer treatment.

7. A nebulizer connector tube for interconnection between a patient face mask provided with a tube fitting of a predetermined circular dimension and including a connector flange formed along the outer edge thereof, and a nebulizer device provided with a tube fitting of a different diametric set dimension comprising an elonged tube having a face mask connector collar at one end and a nebulizer connector collar at the opposing end thereof;
said elongated tube formed from an inert, non-toxic plastic material provided with a bellows type configuration along the length thereof between the face mask connector collar and the nebulizer connector collar,
said bellows type configuration being flexible and resilient,
said face mask connector collar further including a circular channel formed therein and sized to allow the seatment therein of said face mask tube fitting connector flange therein such that said nebulizer tube will swivel relative to said face mask tube fitting,
said face mask connector collar being sized to engage the face mask tube fitting and said nebulizer connector collar being sized to engage said nebulizer tube fitting,
whereby said nebulizer connector tube permits the patient receiving nebulizer treatment to assume any desired position while the connection to the nebulizer allows the nebulizer to retain an upright position regardless of the patient's position relative thereto.
